(19) United States
(12) Patent Application Publication
(10) Pub. No.: US 2015/0121488 A1
(43) Pub. Date: Apr. 30, 2015

(54) MULTI-FACTOR AUTHENTICATION BASED ON IMAGE FEEDBACK LOOP

(71) Applicants: Robert L. Vaughn, Albuquerque, NM (US); Siu Kit Wai, Lam Tin (CN)

(72) Inventors: Robert L. Vaughn, Albuquerque, NM (US); Siu Kit Wai, Lam Tin (CN)

(21) Appl. No.: 14/126,890

(22) PCT Filed: Oct. 25, 2013
(86) PCT No.: PCT/US2013/066894

§ 371 Date: Dec. 17, 2013

(51) Int. Cl. H04L 29/06

(52) U.S. Cl. CPC H04L 63/08
USPC 726/6

(57) ABSTRACT

Methods and apparatus relating to multi-factor authentication based on image feedback are described. In an embodiment, authentication logic, at a first computing device, authenticates a second computing device based at least partially on a comparison of a unique identifier, to be generated for the second computing device and to be displayed on a display device of the first computing device, and a detected unique identifier to be received from the second computing device. Other embodiments are also claimed and described.

### FIELD

The present disclosure generally relates to the field of computing. More particularly, an embodiment generally relates to multi-factor authentication based on image feedback.

### BACKGROUND

As users increase their utilization of various services over computer networks (such as the Internet), securing the exchanged information over such networks becomes of chief concern and importance. However, as the number and/or type of computing devices increase, so does the complexity of securing the information exchange. Accordingly, more efficient and secure techniques are needed to secure the exchange of information over networks.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 shows an example of authentication between two devices, according to an embodiment.

FIG. 2 illustrates a flow diagram of a method to utilize a first computing device to unlock a second computing device, according to an embodiment.

FIG. 3 illustrates a flow diagram of a validation method, according to an embodiment.

FIGS. 4-6 illustrate block diagrams of embodiments of computing systems, which may be utilized to implement some embodiments discussed herein.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware (FM), or some combination thereof.

Some embodiments provide multi-factor authentication based on image feedback (e.g. to combat potential information system compromises). In an embodiment, integrated camera(s) (e.g., in a mobile device such as a smartphone, tablet, UMPC (Ultra-Mobile Personal Computer), laptop computer, Ultrabook™ computing device, smart watch, smart glasses, etc.) are leveraged as a second or third vector of authorization. For example, a camera is used to establish spatial proximity between a plurality of computing devices and to facilitate the exchange of security/cryptographic keys or codes. Once a computing device is authenticated, it may be allowed access to one or more secured resources as will be further discussed below.

For example, if a trust relationship already exists between a user's smartphone and notebook (e.g., where the user can check email on the smartphone), this trust relationship is leveraged to provide for a faster login process on the notebook, to request cash from a bank ATM (Automatic Teller Machine), etc. Various usage models are envisioned that include but are not limited to: (a) interact faster with a banking ATM system without touching it; (b) unlock user desktop (or docked Ultrabook device) as the user walks up to it; or (c) very fast, flexible, and ad hoc gate management (flow of people into a secure area). Hence, some embodiments provide for authentication of a user between two trusted devices by leveraging integrated camera(s) and display(s). Also, various embodiments increase the level of security through multi-factor authentication and/or improve the user experience across several usage models.

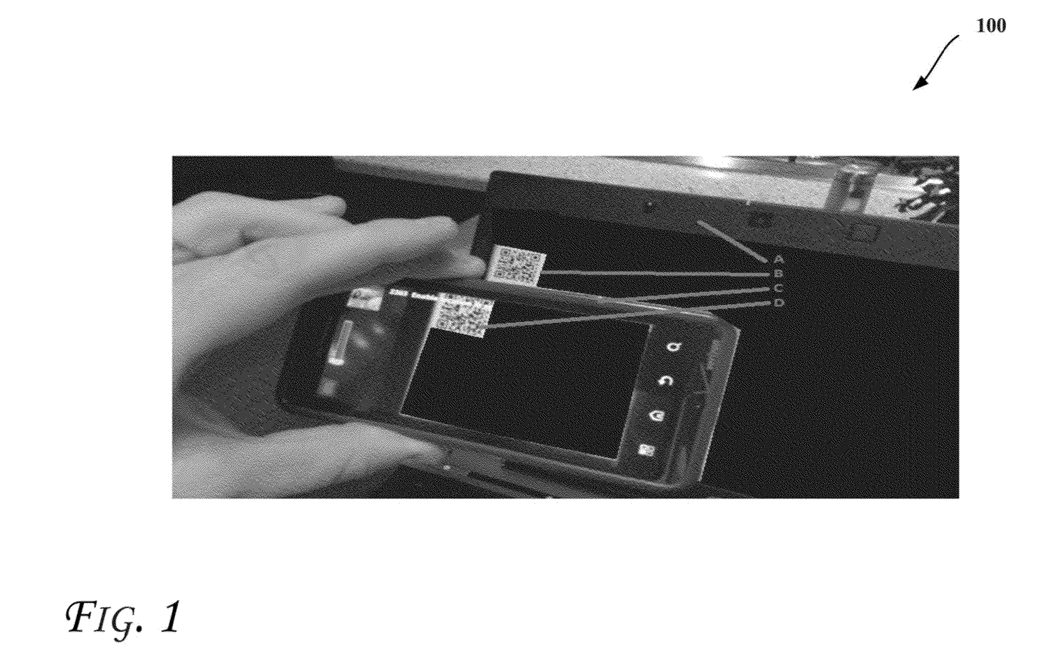

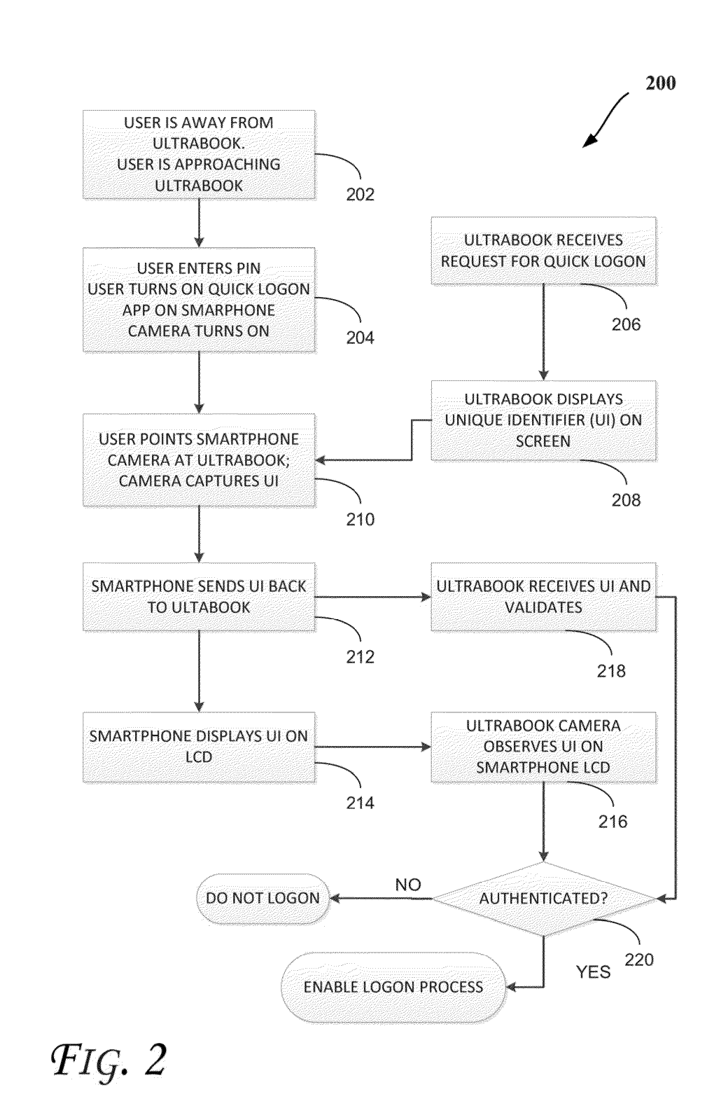

FIG. 1 shows an example 100 of authentication between two devices, according to an embodiment. As shown, an Ultrabook device displays a QR (Quick Response) code (e.g., a Unique Identifier (UI)) which is then captured by smartphone and transmitted back to the Ultrabook device as will be further discussed with reference to FIG. 2. In FIG. 1, (A) is an Ultrabook device, (B) is the Ultrabook device displaying the QR code (e.g. as a unique identifier), (C) is a smartphone; and (D) is an application on the smartphone recognizing the QR code.

In some embodiments, one or more cameras and one or more displays (e.g. LCD (Liquid Crystal Display)) on two or more computing devices are used to exchange information optically as one factor, while a traditional login/password (e.g., AAA (Authentication, Authorization and Accounting)) could be used as a second factor for authentication purposes. Also, through the exchange of information optically, a third factor of spatial proximity would be established, as in “if I can see you seeing me then you are near me.”

FIG. 2 illustrates a flow diagram of a method 200 to utilize a first computing device to unlock a second computing device, according to an embodiment. In some embodiments, one or more components of the other figures discussed herein (such as one or more processor cores, display devices, image capture devices or cameras, etc.) perform one or more operations of FIG. 2. Referring to FIG. 2, the flow diagram for a use case is shown where a user utilizes a smartphone to unlock an Ultrabook device. While some examples describe a two factor authentication method, the embodiments are equally applicable to multiple (e.g. two or more) factors. Also, while some embodiments are discussed with reference to an Ultrabook device and a smartphone for illustrative purposes, the same techniques may be applied to any type of mobile devices (including a smartphone, tablet, UMPC (Ultra-Mobile Personal Computer), laptop computer, Ultrabook™ computing device, smart watch, smart glasses, etc.). More particularly, a trusted connection is established between two devices through the use of active directory records that bind a user's smartphone and notebook (or Ultrabook device) to their user ID or user identifier. Moreover, an already trusted connection is leveraged to facilitate a quicker login to a notebook (or other computing device). An embodiment makes use of cameras that are built into the user's smartphone and their Ultrabook device (as an example).

At an operation 202, a user is away from her Ultrabook device. For example, the Ultrabook device is on her desk and she has gone off to lunch. After lunch the user goes back to the office. While walking up to her computer (at operation 202), she enables the quick logon application at operation 204. To do this, she enters the PIN (Personal Identification Number) into her smartphone then launches the quick logon application. The quick logon application launches the camera on the smartphone at operation 204. The quick logon application can communicate through the network (e.g., WiFi (Wireless Fidelity), 3G (3rd Generation Wireless Format), 4G (4th Generation (wireless/mobile communications), LTE (Long Term Evolution (3G/4G), etc.).

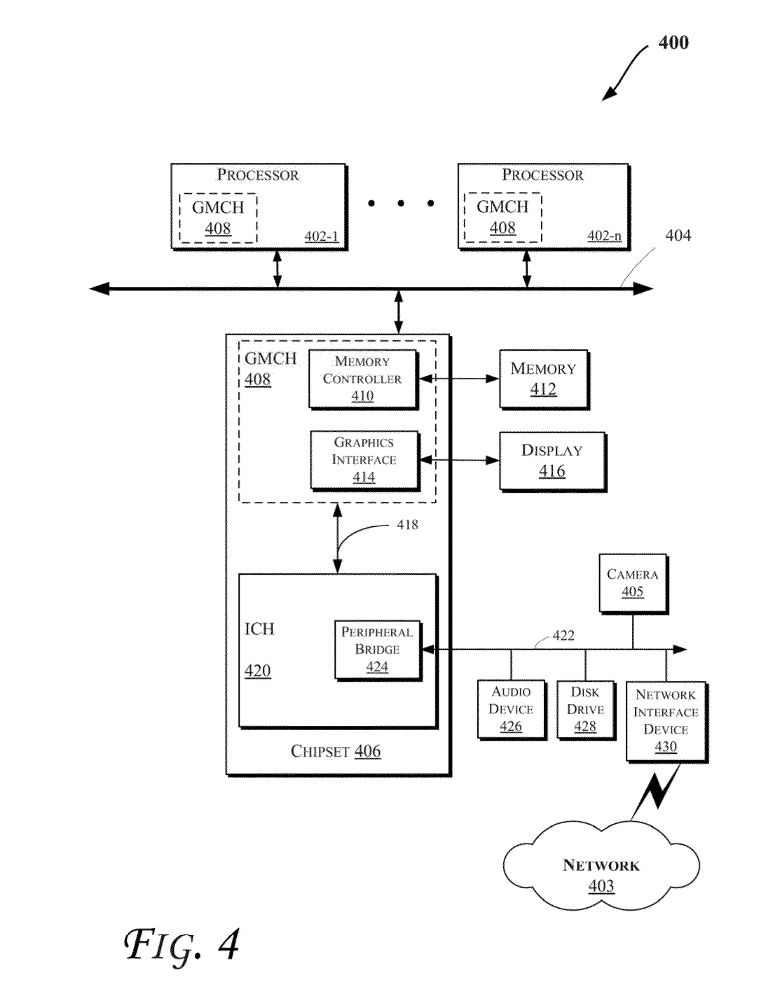

At operation 206, the Ultrabook device receives a request (e.g., via the computer network) for quick logon (e.g., initiated by the quick logon application on the smartphone). At an operation 208, the Ultrabook device displays a Unique Identifier (UI) code on its screen (which could be a QR style code in an embodiment). The user approaches the Ultrabook device and the user points the Smartphone's camera at the Ultrabook device's camera and the smartphone camera captures video/image(s) of the UI code at an operation 210. At an operation 212, the smartphone sends the captured image of the UI code back to the Ultrabook device (for example, electronically via a computer network (such as those discussed herein. e.g., with reference to FIG. 4) or optically as will be further discussed with reference to operation 214 below). For example, the quick logon application may share the smartphone camera view with the user's Ultrabook device.

In an embodiment, both the smartphone and the Ultrabook device take pictures of each other's screens. For example, at an operation 214, the smartphone displays the captured UI on its LCD. In turn, the Ultrabook device's camera observes the UI displayed on the smartphone display at an operation 216.

At operation 218, the Ultrabook device receives the UI from the smartphone (per operation 212) and validates/compares the received UI against the UI that the Ultrabook device displayed at operation 208. At an operation 220 (following operations 216 and/or 218), if the comparisons are authenticated, the logon process is enabled; otherwise, the logon is blocked.

In some implementations, it should take about one second to unlock an Ultrabook device via method 200. Also, the flow may be embedded in the ME (Management Engine) to allow for power on of the Ultrabook device from a powered off state. Some factors regarding applicability of the embodiments are as follows. The two devices may be trusted through a common user ID. Also, when the Ultrabook device displays the unique identifier, it is only displayed on the screen of that Ultrabook device. It is only the smartphone that is bound to the shared user ID that can then transmit the user ID back. Optionally, the Ultrabook device could use its video camera to observe the smartphone user observing the Ultrabook device. This could potentially provide two additional factors: (1) could be implemented as direct (e.g., I know who you are) biometric or as simple context (e.g., I know you are a person) biometric; and/or (2) could be implemented as a second channel for acknowledging the unique identifier. This feature is best described as the Ultrabook device generates a unique identifier, the identifier (e.g., a graphic image) is seen by the smartphone and send via network back to the Ultrabook device and the smartphone (if camera exists on the LCD side) displays the image on its LCD for the Ultrabook device to detect. While SMS (Short Message Service), NFC (Near Field Communication), RFID (Radio Frequency Identification), WiFi (Wireless Fidelity) or Smartphone push may be used to augment the techniques discussed herein, they may not be as useful by themselves. For example, SMS has sufficient range or reach, when transported across electromagnetic waves such as is implemented in 3G or LTE networks, that a third party outside of the immediate vicinity of the Ultrabook device could intercept the exchange. Additionally, SMS does not have the benefit of required proximity. WiFi also has sufficient radio frequency range that a third party outside of the immediate vicinity of the Ultrabook device could intercept the exchange. Additionally, the Ultrabook device could become unlocked accidently when the user is walking nearby and not intending to unlock the Ultrabook device. NFC is similar method that could accomplish the same basic actions but may be perceived as slower because the user has to actually touch the Ultrabook device with the smartphone. NFC latency is about one second (by observation). RFID has the same problem as WiFi; namely, the distance of radio signal transmission is too great which increases the potential of compromise. And, smartphone push is simply too cumbersome to be of any benefit for hastening a login process. Hence, electromagnetic energy transmitted wirelessly can be intercepted in manner materially different from optical (visible wavelengths) transmission systems.

Furthermore, some embodiments provide a multi-factor approach since, for example, the shared user ID represents a trust, the exchange of a unique identifier supports trust via an exchange of private information between trusted devices, the video requirement represents spatial proximity and mitigates third party (or “man in the middle”) compromises, and/or that the smartphone has a PIN.

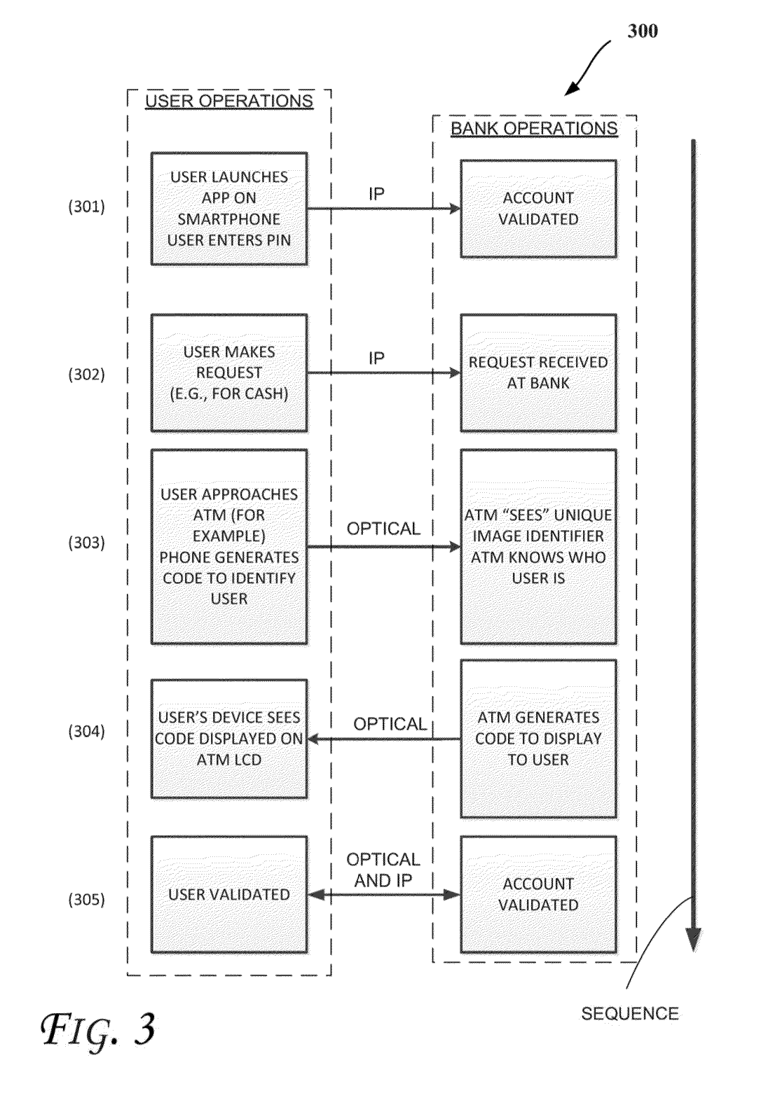

FIG. 3 illustrates a flow diagram of a validation method 300, according to an embodiment. In some embodiments, one or more components of the other figures discussed herein (such as one or more processor cores, display devices, image capture devices or cameras, etc.) perform one or more operations of FIG. 3.

Furthermore, for the sake of simplicity two devices will be generally discussed herein; however, embodiments are not limited to two devices and more than two devices may be used. For example, Device “A” is a mobile device such as a smartphone with an embedded camera. Device “B” is a stationary/non-moving device such as a desktop computer, docked Ultrabook device, or a bank ATM. Also, while some embodiments are discussed with reference to a smartphone for illustrative purposes, the same techniques may be applied to any type of mobile devices (including a smartphone, tablet, UMPC (Ultra-Mobile Personal Computer), laptop computer, Ultrabook™ computing device, smart watch, smart glasses, etc.). Additionally, for the sake of simplicity, the following example will be described in the context of a user making a withdrawal of cash from an ATM. The setup or configuration would be relatively straight forward and might involve the end user simply installing the bank's application on a smartphone.

Referring to FIG. 3, at an operation 301, the user approaches the bank ATM with the intent of conducting a transaction to receive some cash (e.g., by launching an application on user's smartphone and entering a PIN that is passed to the bank via a network such as a computer network, cellular network, etc. (shown as Internet Protocol (IP) in FIG. 3) and the account information is validated on the bank server. At an operation 302, while waiting in line for the ATM or as the user is walking up to the ATM, the user logs into the banking web site from a tablet or smartphone with a front facing camera and makes a request (e.g., for cache) that is received at the bank via IP. Most Smartphones have two cameras, but the system could work with just one camera.

After operation 302, the user is now logged into the banking site on the mobile device. The user may have previously or just now put in a request for money in the bank's smartphone application. The user simply requests cash. The user does not have to specify where the ATM is for operation 302.

At operation 303, the user approaches the ATM and points the Smartphone's display (that now shows a generated UI to identify the user) at the ATM's camera. Once the ATM detects the UI or unique image displayed on the smartphone, the ATM recognizes the user. At an operation 304, the ATM generates a unique graphic, logo, character string, or UI (e.g. a QR code) that is displayed on the ATM's LCD and the user's device in turn detects the code displayed on the ATM LCD. The bank's application on the user's device captures the device optically using its camera and the bank application on the user's device transmits the image identifier to the bank's backend service/server. As marked in FIG. 3, operations 303 and/or 304 are performed via optical communication. Because the bank knows from which account the image identifier is received and the image identifier is unique to a specific ATM for a specific instance the user is authenticated at an operation 305.

Optionally, e.g., for greater security, operation 304 is performed to allow the bank to render an image back to the smartphone. The user can display that image to the ATM's camera and the optical validation becomes reinforced. The ATM then receives confirmation of the identifier being valid and the request for cash. Subsequently, the ATM dispenses requested the cash. Accordingly, some unique features include: (a) no PIN is required at the ATM; (b) the user is able to make the request for cash before walking up to the ATM; and/or (c) the user does not have to physically touch the ATM (this feature is important because ATMs can be compromised by card readers installed on top of the ATM's card reader).

Moreover, the above-described bank transaction has a few factors to consider: (1) the application on the device is password protected. Every bank application is password protected so the user does not have to perform any extra steps; (2) the bank generates a unique code that is sent to the user. The bank has both historical data associating that smartphone with the account owner, as well as the unique code proving that the phone belonging to the authorized account user is physically close to the ATM; and/or (3) facial recognition is unnecessary per banking standards (e.g., as most banks do not require that the person making requests from the account be actually the same person and only require that the correct credentials be entered).

Optionally and leveraging IPT (Identity Protection Technology), one may build part of these functions into silicon so that the secure key inside the smartphone is used with the bank's certificate to produce a unique identifier that proves that the device making the request is the authorized device. This would help prove that the device is protected by the hardware and not tampered/hacked by OS or malware.

Furthermore, in various embodiments, one or more of the following features may be provided:
1. Ability to unlock desktop or docked Ultrabook device as the user walks up to the computer.
2. Ability to switch user/profile on a desktop or docked Ultrabook device as the user walks up to the computer.
3. Ability to stage applications (for example, as in open Microsoft® Excel, open email messages, etc.) from a smartphone to then be opened when the user sits down at their desk.
4. Transfer state from smartphone to Ultrabook device (as in YouTube video being viewed on smartphone and then transferred to Ultrabook device).
5. Ability to integrate into automobile security system to provide for unlock/car start/radio settings/etc. and use the camera to camera model to unlock.
6. Additionally, biometrics could be included to provide third or fourth level factors in authentication.

In some embodiments. Intel® IPT and/or PTD (Protected Transaction Display) technologies could be used to mask the screen except for the part of the screen that generates the unique identifier.

FIG. 4 illustrates a block diagram of a computing system 400 in accordance with an embodiment. The computing system 400 may include one or more central processing unit(s) (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. Additionally, the operations discussed with reference to FIGS. 1-3 may be performed by one or more components of the system 400. Also, various devices discussed with reference to FIGS. 1-3 (such as the ATM, smartphone, tablet, UMPC (Ultra-Mobile Personal Computer), laptop computer, Ultrabook™ computing device, smart watch, smart glasses, etc.) may include one or more of the components of FIG. 4.

For example, memory 412 may store the bank application discussed with reference to FIG. 3 that is executed on processor(s) 402. Also, system 400 may include an image capture device 405. Moreover, the scenes, images, or frames discussed herein (e.g. which may be processed by the graphics logic in various embodiments) may be captured by the image capture device 405 (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as display 416, including for example a flat panel display device, etc.).

A chipset 406 may also communicate with the interconnection network 404. The chipset 406 may include a Graphics and Memory Control Hub (GMCH) 408. The GMCH 408 may include a memory controller 410 that communicates with a memory 412. The memory 412 may store data, including sequences of instructions, that may be executed by the CPU 402, or any other device included in the computing system 400. In one embodiment, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with a display device 416. In one embodiment, the graphics interface 414 may communicate with the display device 416 via an accelerated graphics port (AGP) or Peripheral Component Interconnect (PCI) (or PCI express (PCIe) interface). In an embodiment, the display 416 (such as a flat panel display) may communicate with the graphics interface 414 through, for example, a signal converter that translates a digital representation of an image stored in a storage device such as video memory or system memory into display signals that are interpreted and displayed by the display 416. The display signals produced by the display device may pass through various control devices before being interpreted by and subsequently displayed on the display 416.

A hub interface 418 may allow the GMCH 408 and an input/output control hub (ICH) 420 to communicate. The ICH 420 may provide an interface to I/O device(s) that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g. through multiple bridges or controllers. Moreover, other peripherals in communication with the ICH 420 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices. The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the GMCH 408 in some embodiments. In addition, the processor 402 and the GMCH 408 may be combined to form a single chip and/or a portion or the whole of the GMCH 408 may be included in the processors 402 (instead of inclusion of GMCH 408 in the chipset 406, for example). Furthermore, the graphics accelerator 416 may be included within the GMCH 408 in other embodiments.

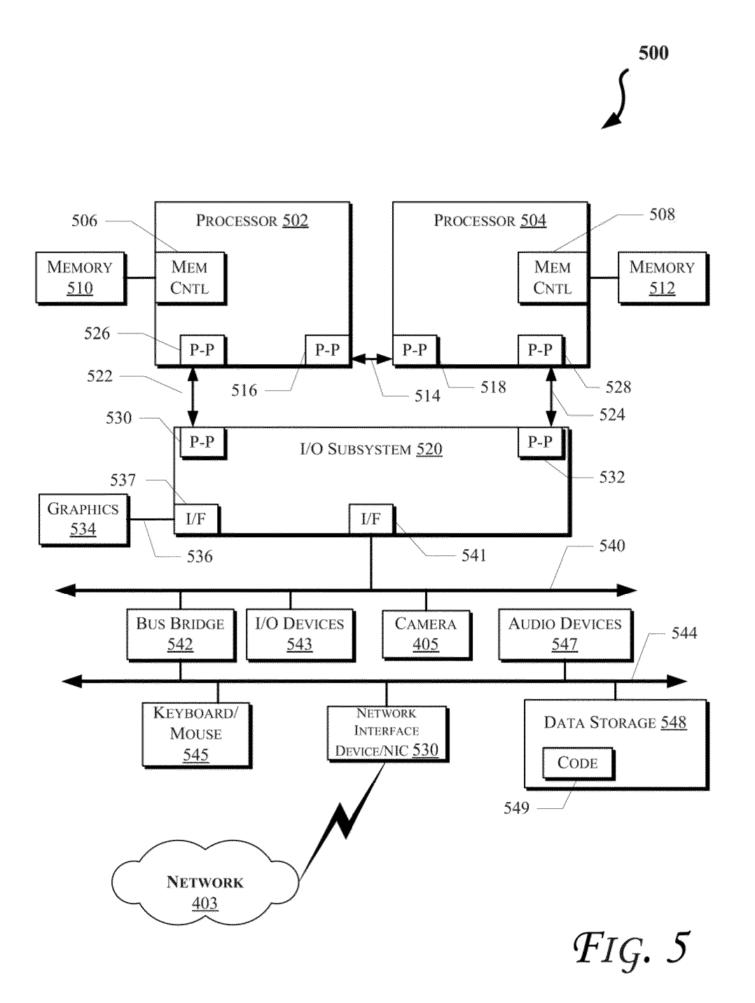

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration such as discussed with reference to FIG. 5. For example, processors, memory, and/or input/output devices may be interconnected by a number of point-to-point interfaces.

More specifically, FIG. 5 illustrates a computing system 500 that is arranged in a point-to-point (PtP) configuration, according to an embodiment. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a graphics circuit 534 via a graphics interface 536, e.g. using a PIP interface circuit 537.

At least one embodiment may be provided within the processors 502 and 504. Also, the operations discussed with reference to FIGS. 1-4 may be performed by one or more components of the system 500. For example, the bank application discussed with reference to FIG. 3 may be stored in memory 510 or 512. Also, various devices discussed with reference to FIGS. 1-4 (such as the ATM, smartphone, tablet, UMPC (Ultra-Mobile Personal Computer), laptop computer, Ultrabook™ computing device, smart watch, smart glasses, etc.) may include one or more of the components of FIG. 5. System 500 may further include the image capture device 405.

Other embodiments, however, may exist in other circuits, logic units, or devices within the system 500 of FIG. 5. Furthermore, other embodiments may be distributed throughout several circuits, logic units, or devices illustrated in FIG. 5.

The chipset 520 may communicate with a bus 540 using a PtP interface circuit 541. The bus 540 may communicate with one or more devices, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device 547, and/or a data storage device 548. The data storage device 548 may store code 549 that may be executed by the processors 502 and/or 504.

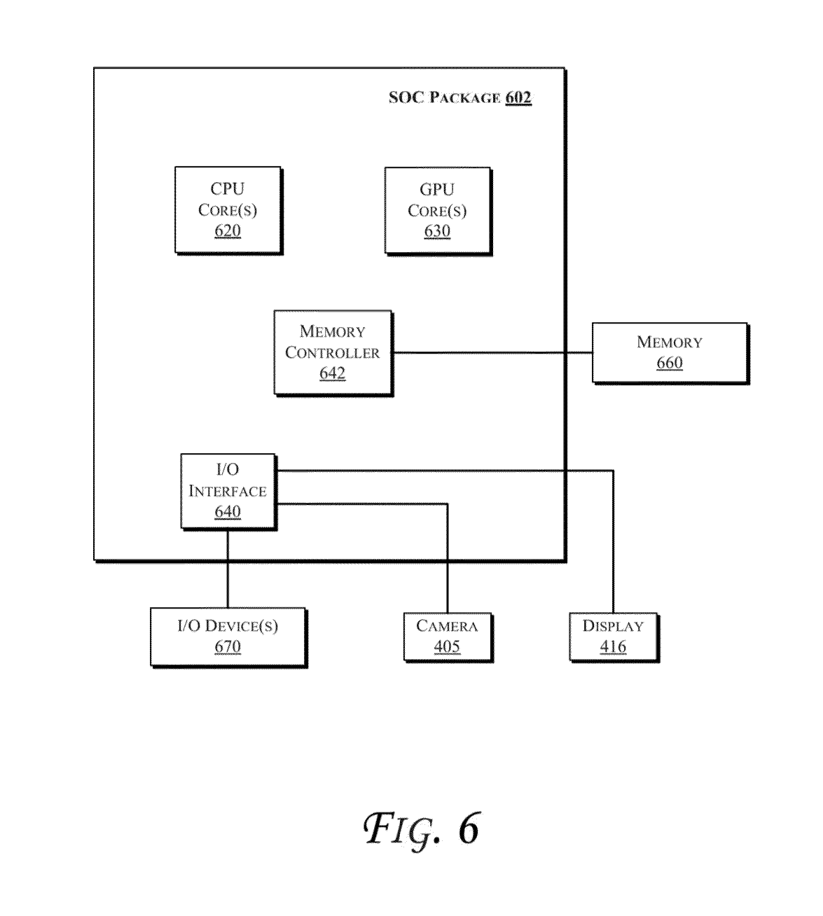

In some embodiments, one or more of the components discussed herein can be embodied as a System On Chip (SOC) device. FIG. 6 illustrates a block diagram of an SOC package in accordance with an embodiment. As illustrated in FIG. 6, SOC 602 includes one or more Central Processing Unit (CPU) cores 620, one or more Graphics Processor Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 620 may include one or more other components, e.g., as discussed with reference to the other figures herein. In one embodiment, SOC package 602 (and its components) is provided on one or more Integrated Circuit (IC) die, e.g., which are packaged into a single semiconductor device.

As illustrated in FIG. 6, SOC package 602 is coupled to a memory 660 (which may be similar to or the same as memory discussed herein with reference to the other figures) via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display (e.g., display 416), an image/video capture device (such as a camera or camcorder/video recorder (e.g., camera 405 of FIG. 4 or 5)), a touch screen, a speaker, or the like.

The following examples pertain to further embodiments. Example 1 includes an apparatus comprising: authentication logic, at a first computing device, to authenticate a second computing device based at least partially on a comparison of a unique identifier, to be generated for the second computing device and to be displayed on a display device of the first computing device, and a detected unique identifier to be received from the second computing device. Example 2 includes the apparatus of example 1, wherein the detected unique identifier is to be received from an image capture device of the second computing device. Example 3 includes the apparatus of example 1, wherein the detected unique identifier is to be based at least partially on a detection of the displayed unique identifier. Example 4 includes the apparatus of example 1, wherein an image capture device of the first computing device is to detect a redisplay of the detected unique identifier by the second computing device. Example 5 includes the apparatus of example 4, wherein the authentication logic is to authenticate the second computing device based at least partially on a comparison of the redisplayed unique identifier and the displayed unique identifier. Example 6 includes the apparatus of example 1, wherein the authentication logic is to authenticate the second computing device based at least partially on personal identification information to be received from the second computing device. Example 7 includes the apparatus of example 1, wherein the authentication logic is to authenticate the second computing device in response to a request to be received from the second computing device. Example 8 includes the apparatus of example 1, wherein the authentication logic is to authenticate the second computing device based at least partially on a unique user identification code to be received from the second computing device. Example 9 includes the apparatus of example 1, wherein the first computing device is to comprise a mobile computing device selected from a group comprising: a smartphone, tablet, UMPC (Ultra-Mobile Personal Computer), laptop computer, Ultrabook™ computing device, smart watch, or smart glasses. Example 10 includes the apparatus of example 1, wherein the detected unique identifier is to be received at the first computing device electronically or optically. Example 11 includes the apparatus of example 1, wherein the unique identifier or the detected unique identifier are to comprise a quick response code.

Example 12 includes a method comprising: authenticating, at a first computing device, a second computing device based at least partially on a comparison of a unique identifier, generated for the second computing device and displayed on a display device of the first computing device, and a detected unique identifier received from the second computing device. Example 13 includes the method of example 12, further comprising receiving the detected unique identifier from an image capture device of the second computing device. Example 14 includes the method of example 12, further comprising detecting a redisplay of the detected unique identifier by the second computing device at an image capture device of the first computing device. Example 15 includes the method of example 14, further comprising authenticating the second computing device based at least partially on a comparison of the redisplayed unique identifier and the displayed unique identifier. Example 16 includes the method of example 12, further comprising authenticating the second computing device based at least partially on one or more of: personal identification information received from the second computing device; or a unique user identification code received from the second computing device. Example 17 includes the method of example 12, further comprising authenticating the second computing device in response to a request received from the second computing device. Example 18 includes the method of example 12, further comprising the first computing device allowing access to one or more secured resources in response to authentication of the second computing device. Example 19 includes the method of example 12, further comprising receiving the detected unique identifier at the first computing device electronically or optically. Example 20 includes the method of example 12, wherein the unique identifier or the detected unique identifier comprise a quick response code. Example 21 includes a computing system comprising: a first computing device having one or more processor cores; memory to store data to be accessed by at least one of the processor cores; authentication logic, at the first computing device, to authenticate a second computing device based at least partially on a comparison of a unique identifier, to be generated for the second computing device and to be displayed on a display device of the first computing device, and a detected unique identifier to be received from the second computing device, wherein the detected unique identifier is to be received from an image capture device of the second computing device and wherein the detected unique identifier is to be based at least partially on a detection of the displayed unique identifier. Example 22 includes the system of example 21, wherein an image capture device of the first computing device is to detect a redisplay of the detected unique identifier by the second computing device. Example 23 includes the system of example 22, wherein the authentication logic is to authenticate the second computing device based at least partially on a comparison of the redisplayed unique identifier and the displayed unique identifier. Example 24 includes an apparatus comprising means for performing a method as set forth in any of examples 12 to 20. Example 25 includes a computer-readable medium comprising one or more instructions that when executed on a processor configure the processor to perform one or more operations of any of examples 12 to 20.

Example 26 includes a computer-readable medium comprising one or more instructions that when executed on a processor configure the processor to perform one or more operations to: authenticate, at a first computing device, a second computing device based at least partially on a comparison of a unique identifier, generated for the second computing device and displayed on a display device of the first computing device, and a detected unique identifier received from the second computing device. Example 27 includes the computer-readable medium of example 26, further comprising one or more instructions that when executed on the processor configure the processor to perform one or more operations to cause receiving of the detected unique identifier from an image capture device of the second computing device. Example 28 includes the computer-readable medium of example 26, further comprising one or more instructions that when executed on the processor configure the processor to perform one or more operations to cause detection of a redisplay of the detected unique identifier by the second computing device at an image capture device of the first computing device. Example 29 includes the computer-readable medium of example 28, further comprising one or more instructions that when executed on the processor configure the processor to perform one or more operations to cause authentication of the second computing device based at least partially on a comparison of the redisplayed unique identifier and the displayed unique identifier. Example 30 includes the computer-readable medium of example 26, further comprising one or more instructions that when executed on the processor configure the processor to perform one or more operations to cause authentication of the second computing device based at least partially on one or more of: personal identification information received from the second computing device; or a unique user identification code received from the second computing device. Example 31 includes the computer-readable medium of example 26, further comprising one or more instructions that when executed on the processor configure the processor to perform one or more operations to cause authentication of the second computing device in response to a request received from the second computing device. Example 32 includes the computer-readable medium of example 26, further comprising one or more instructions that when executed on the processor configure the processor to perform one or more operations to cause the first computing device to allow access to one or more secured resources in response to authentication of the second computing device. Example 33 includes the computer-readable medium of example 26, further comprising one or more instructions that when executed on the processor configure the processor to perform one or more operations to cause receipt of the detected unique identifier at the first computing device electronically or optically. Example 34 includes the computer-readable medium of claim 26, wherein the unique identifier or the detected unique identifier comprise a quick response code.

In various embodiments, the operations discussed herein, e.g. with reference to FIGS. 1-6, may be implemented as hardware (e.g., logic circuitry), software, firmware, or combinations thereof, which may be provided as a computer program product, e.g. including a tangible (such as a non-transitory) machine-readable or computer-readable medium having stored thereon instructions (or software procedures) used to program a computer to perform a process discussed herein. The machine-readable medium may include a storage device such as those discussed with respect to FIGS. 1-6 (including, for example, ROM, RAM, flash memory, hard drive, solid state drive, etc.). Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection). Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-25. (canceled)

26. An apparatus comprising:
authentication logic, at a first computing device, to authenticate a second computing device based at least partially on a comparison of a unique identifier, to be generated for the second computing device and to be displayed on a display device of the first computing device, and a detected unique identifier to be received from the second computing device.

27. The apparatus of claim 26, wherein the detected unique identifier is to be received from an image capture device of the second computing device.

28. The apparatus of claim 26, wherein the detected unique identifier is to be based at least partially on a detection of the displayed unique identifier.

29. The apparatus of claim 26, wherein an image capture device of the first computing device is to detect a redisplay of the detected unique identifier by the second computing device.

30. The apparatus of claim 29, wherein the authentication logic is to authenticate the second computing device based at least partially on a comparison of the redisplayed unique identifier and the displayed unique identifier.

31. The apparatus of claim 26, wherein the authentication logic is to authenticate the second computing device based at least partially on personal identification information to be received from the second computing device.

32. The apparatus of claim 26, wherein the authentication logic is to authenticate the second computing device in response to a request to be received from the second computing device.

33. The apparatus of claim 26, wherein the authentication logic is to authenticate the second computing device based at least partially on a unique user identification code to be received from the second computing device.

34. The apparatus of claim 26, wherein the first computing device is to comprise a mobile computing device selected from a group comprising: a smartphone, tablet, UMPC (Ultra-Mobile Personal Computer), laptop computer, Ultrabook™ computing device, smart watch, or smart glasses.

35. The apparatus of claim 26, wherein the detected unique identifier is to be received at the first computing device electronically or optically.

36. The apparatus of claim 26, wherein the unique identifier or the detected unique identifier are to comprise a quick response code.

37. A method comprising:
authenticating, at a first computing device, a second computing device based at least partially on a comparison of a unique identifier, generated for the second computing device and displayed on a display device of the first computing device, and a detected unique identifier received from the second computing device.

38. The method of claim 37, further comprising receiving the detected unique identifier from an image capture device of the second computing device.

39. The method of claim 37, further comprising detecting a redisplay of the detected unique identifier by the second computing device at an image capture device of the first computing device.

40. The method of claim 39, further comprising authenticating the second computing device based at least partially on a comparison of the redisplayed unique identifier and the displayed unique identifier.

41. The method of claim 37, further comprising authenticating the second computing device based at least partially on one or more of:
personal identification information received from the second computing device; or
a unique user identification code received from the second computing device.

42. The method of claim 37, further comprising authenticating the second computing device in response to a request received from the second computing device.

43. The method of claim 37, further comprising the first computing device allowing access to one or more secured resources in response to authentication of the second computing device.

44. The method of claim 37, further comprising receiving the detected unique identifier at the first computing device electronically or optically.

45. A computing system comprising:
a first computing device having one or more processor cores;
memory to store data to be accessed by at least one of the processor cores;
authentication logic, at the first computing device, to authenticate a second computing device based at least partially on a comparison of a unique identifier, to be generated for the second computing device and to be displayed on a display device of the first computing device, and a detected unique identifier to be received from the second computing device,
wherein the detected unique identifier is to be received from an image capture device of the second computing device and wherein the detected unique identifier is to be based at least partially on a detection of the displayed unique identifier.

46. The system of claim 45, wherein an image capture device of the first computing device is to detect a redisplay of the detected unique identifier by the second computing device.

47. The system of claim 46, wherein the authentication logic is to authenticate the second computing device based at least partially on a comparison of the redisplayed unique identifier and the displayed unique identifier.

48. A computer-readable medium comprising one or more instructions that when executed on a processor configure the processor to perform one or more operations to:
authenticate, at a first computing device, a second computing device based at least partially on a comparison of a unique identifier, generated for the second computing device and displayed on a display device of the first computing device, and a detected unique identifier received from the second computing device.

49. The computer-readable medium of claim 48, further comprising one or more instructions that when executed on the processor configure the processor to perform one or more operations to cause receiving of the detected unique identifier from an image capture device of the second computing device.

50. The computer-readable medium of claim 48, further comprising one or more instructions that when executed on the processor configure the processor to perform one or more operations to cause detection of a redisplay of the detected unique identifier by the second computing device at an image capture device of the first computing device.
